(19) United States
(12) Patent Application Publication
(10) Pub. No.: US 2008/0115384 A1
(43) Pub. Date: May 22, 2008

(54) Method and Device for Drying Objects, Especially Painted Vehicle Bodies

(76) Inventors: Josef Krizek, Holzgerlingen (DE); Werner Swoboda, Boblingen (DE); Jurgen Hanf, Tuebingen (DE)

Correspondence Address: FACTOR & LAKE, LTD, 1327 W. WASHINGTON BLVD., SUITE 5G/H, CHICAGO, IL, 60607, US

(21) Appl. No.: 11/597,601

(22) PCT Filed: May 12, 2005
(86) PCT No.: PCT/EP05/05131

§ 371 Date: Aug. 16, 2007

(30) Foreign Application Priority Data
May 25, 2004 (DE) 10 2004 025 528.8

(51) Int. Cl. F26B 3/00

(52) U.S. Cl. 34/510; 34/73

(57) ABSTRACT

The invention relates to a method and a device for drying objects (2), especially painted vehicle bodies. According to said method, the objects (2) are displaced through a dry zone (8) wherein they are hardened in an inert gas atmosphere. Inert gas is continuously or intermittently removed from the dry zone (8), and guided along at least one surface which is cooled to a temperature below the dew point of the impurities contained in the inert gas. In this way, the impurities condense on the cooled surface. The relatively costly inert gas can thus be used for a long time.

The invention relates to a method for drying objects, in particular painted vehicle bodies, in which the objects are moved through a drying zone in which they are cured in an inert gas atmosphere,

and to
a device for drying objects, in particular painted vehicle bodies, comprising:
a) a drying tunnel, the interior of which is filled with an inert gas atmosphere;
b) a conveying system with which the objects can be moved through the drying tunnel.

Very recently, paints which must be cured in an inert gas atmosphere, for example, in UV light, in order to prevent undesired reactions with components of the normal atmosphere, in particular oxygen, have gained increasing importance. These novel paints are distinguished by very high surface hardness and short polymerisation times. In painting installations operated with continuous throughput, the last-mentioned advantage is directly reflected in shorter installation lengths, which, of course, leads to considerably lower investment costs.

Whereas, in conventional driers and drying methods operating with normal air as the atmosphere, the quantity of air which is introduced into the drier and removed therefrom is of lesser importance for cost reasons, in the case of inert gas atmospheres care must be taken to achieve the lowest possible consumption.

It is the object of the present invention so to configure a method and a device of the type mentioned in the introduction that it is possible to operate for as long as possible with the same inert gas.

This object is achieved, with regard to the method, in that inert gas is withdrawn continuously or intermittently from the drying zone, which inert gas is conducted along at least one surface which is cooled to a temperature below the temperature of impurities contained in the inert gas in such a way that the impurities condense out on the cooled surface.

It is recognised with the present invention that the “service life” of the inert gas during drying depends very heavily on the degree to which impurities emanating from the objects to be dried or entrained therewith are concentrated in the inert gas. If the concentration of the impurities in the inert gas increases too much, the surface quality of the objects dried is impaired. According to the invention, therefore, inert gas is withdrawn continuously or repeatedly from the drying zone. The impurities contained in the withdrawn inert gas are condensed out on a cold surface, that is, they are removed from the inert gas, which can then be returned to the drying zone in a purified state. In this way the inert gas can be continuously circulated, only the unavoidable losses, which escape via leaks or via the inlet or outlet of the drying zone, needing to be replaced. This economical utilisation of inert gas keeps the costs of the inventive method low.

The method in which the cooled surface is cooled by means of Peltier elements is especially advantageous. Peltier elements are commercially available at low cost and require minimum complexity and cost in terms of apparatus in order to achieve the cooling effect.

The use of Peltier elements is also especially advantageous in the following context: the temperature of the inert gas falls as it flows past the cooled surface. This may be desired in a particular case, namely if (for reasons not of interest here) zones are present in the total installation in which a cooled inert gas atmosphere prevails. In that case the cold inert gas freed of impurities can be conducted to these zones. If that is not the case, however, the cooled, purified inert gases must be reheated to the operating temperature prevailing in the drier. If Peltier elements are used for cooling, the heat emitted by said Peltier elements can be utilised for reheating the inert gas after it has flowed past the cooled surface.

Another advantageous possibility of cooling the plates is that of using inert gas drawn from a pressure accumulator, which inert gas has cooled through decompression, as the cooling medium. In particular, the inert gas which is fed back to the installation to replace lost inert gas may be used for this purpose.

Low-viscosity condensed impurities may be allowed simply to drain from the appropriately oriented cooled surface. They can then be disposed of in an appropriate manner without necessitating interruption of operation for this purpose.

By contrast, condensed impurities which are solid or have high viscosity should be removed from the cooled surface mechanically and/or by solvents at the given time intervals.

The above-mentioned object is achieved, with regard to the device, in that:
e) a condensation device is provided to which inert gas from the drier tunnel can be supplied via a conduit and which includes at least one component having a surface against which the inert gas can flow and which can be cooled to below the dew point of the impurities entrained by the inert gas.

The advantages of the device according to the invention are analogous to the above-mentioned advantages of the method according to the invention. The advantageous embodiments of the device according to the invention specified in claims 8 to 13 also predominantly have an analogue in one of the above-mentioned variants of the method, and corresponding advantages. Reference may be made thereto.

Embodiments of the invention are explained in more detail below with reference to the drawings, in which:

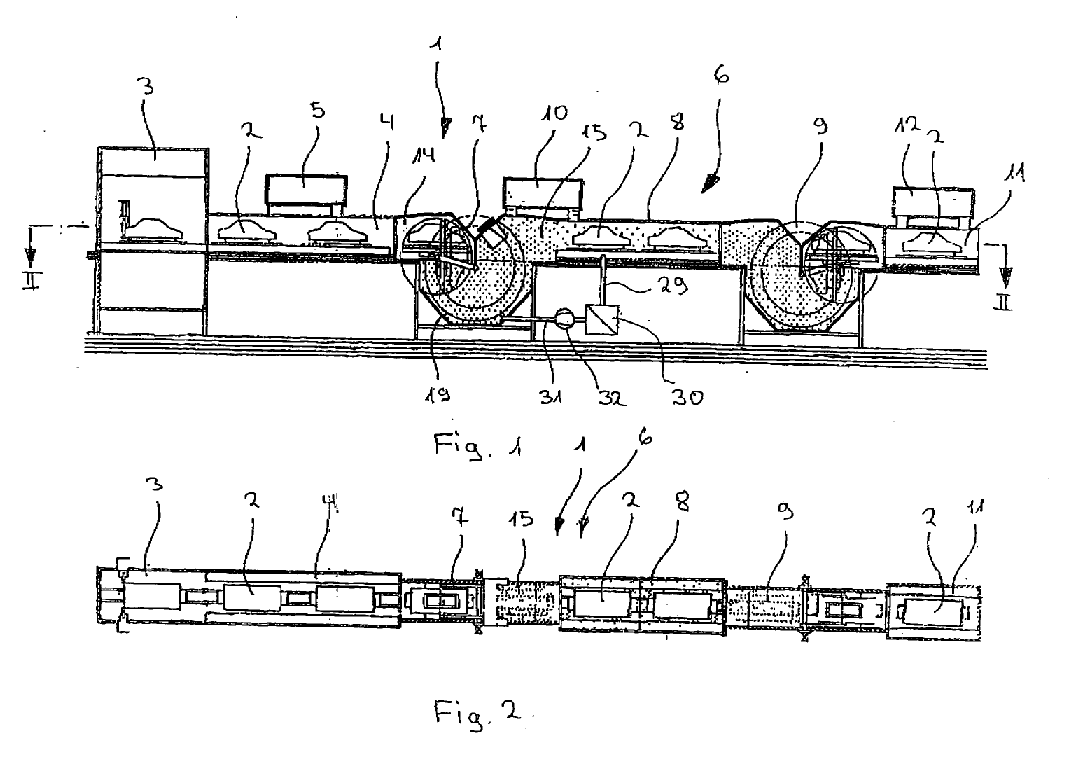

FIG. 1 shows a portion of a painting installation including a first embodiment of a drier according to the invention in vertical section;

FIG. 2 shows a section through the installation of FIG. 1 along the line II-II in that Figure;

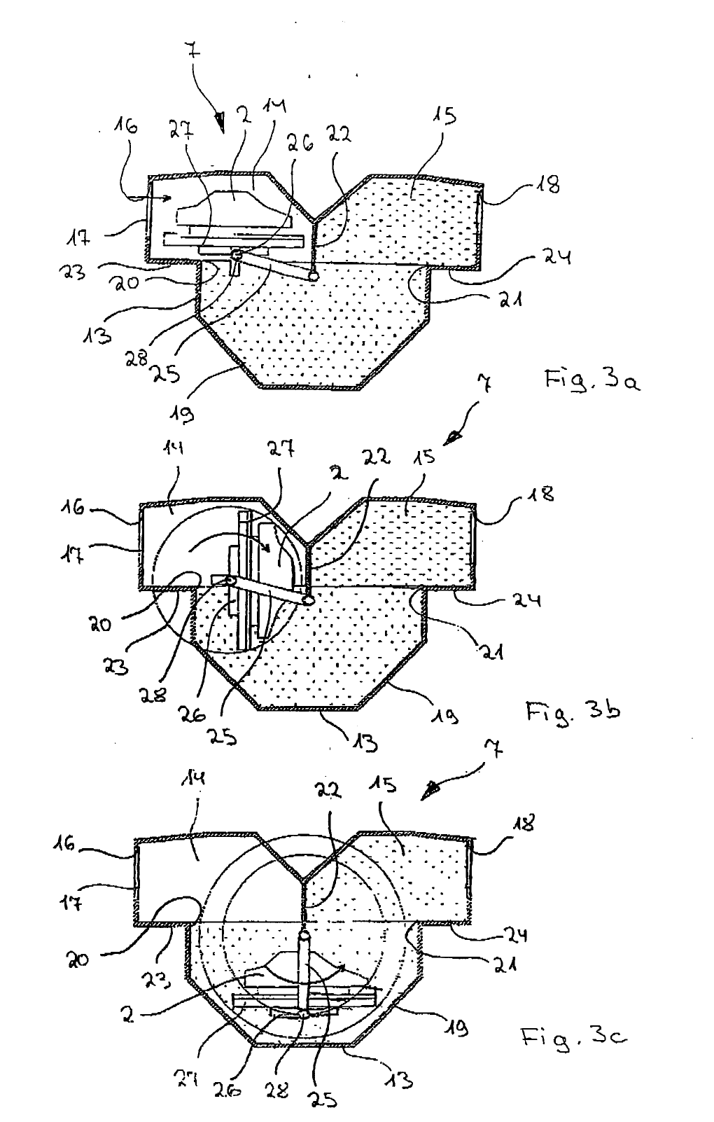

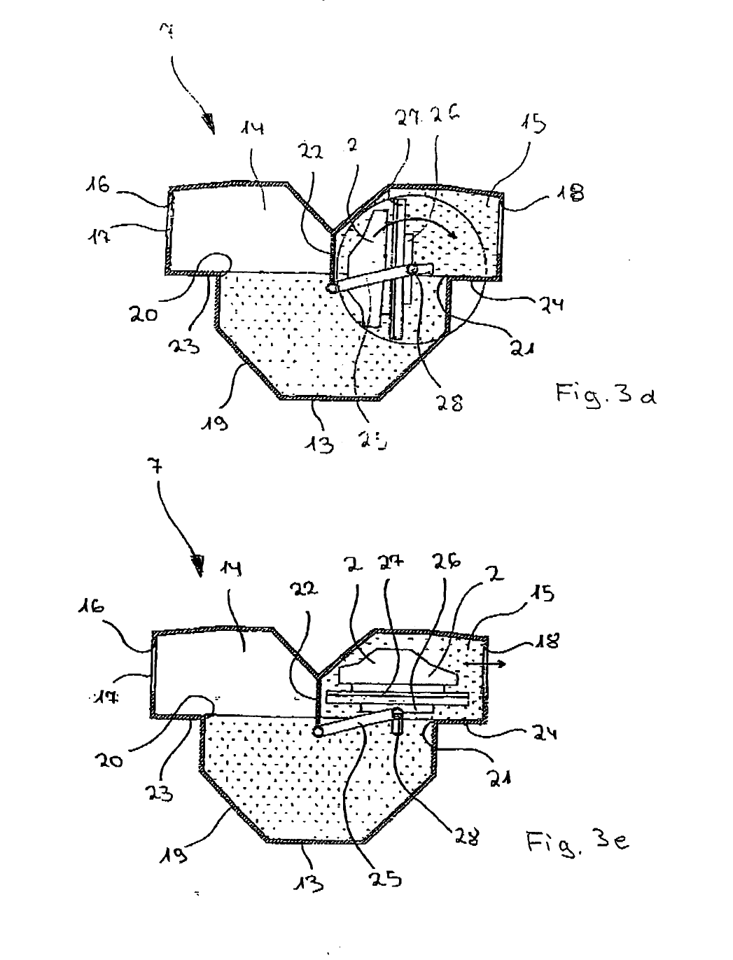

FIGS. 3a to 3e show different positions of a vehicle body in a lock of the installation of FIGS. 1 and 2;

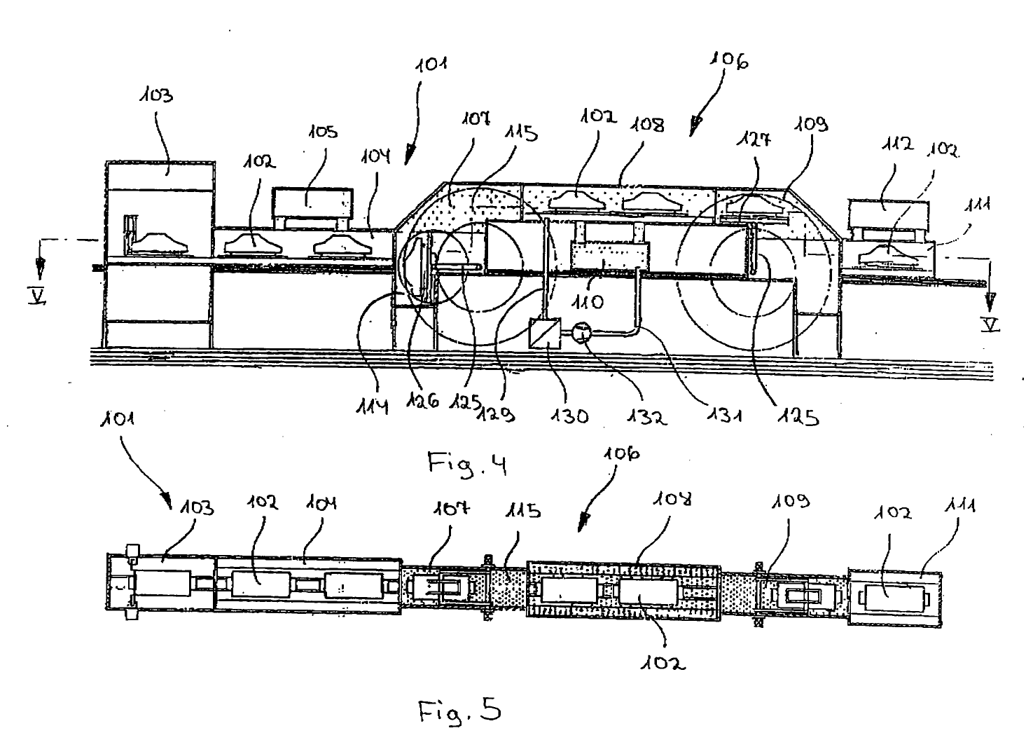

FIG. 4 shows a portion of a painting installation including a second embodiment of a drier according to the invention in vertical section;

FIG. 5 shows a section of along the line V-V of FIG. 4, which line contains two steps and is partially offset vertically.

Reference will first be made to FIGS. 1 and 2, in which a portion of a painting installation is denoted as a whole by reference 1. The painting installation 1 is used for painting vehicle bodies 2; various treatment stations (not shown) are arranged in known fashion before and after the portion illustrated. The vehicle bodies 2 pass through the painting installation 1 in FIGS. 1 and 2 from left to right. They first enter the spray cabin 3 in which they are coated with paint in known fashion. The precise construction of the spray cabin 3 and the type of application of the paint is irrelevant in the present context.

From the spray cabin 3 the vehicle bodies 2 first reach a pre-drier 4, the detailed construction of which is likewise not of interest and is known to the person skilled in the art. In the pre-drier 4 a first expulsion of the solvents takes place at a temperature from 40° C. to 150° C. For this purpose the air contained in the pre-drier 4 is circulated, for example, via a heating unit 5.

The pre-drying may also be carried out by relatively long residence times in an unheated, ventilated zone instead of a pre-drier, solvents being evaporated and degassed, depending on the type of paint used.

From the pre-drier 4 the vehicle bodies 2 are moved into the main drier 6, which is made up of an inlet lock 7, a drying tunnel 8 and an outlet lock 9.

An inert gas atmosphere is present in the drying tunnel 8; it is therefore filled, for example, with CO₂, nitrogen or in some cases with helium. A temperature from 40° C. to 150° C. prevails in the drying tunnel 8, and is obtained in the embodiment illustrated by circulating the inert gas via a heating unit 10. In the locks 7 and 9 the vehicle bodies 2 are moved into and out of the inert gas atmosphere of the drying tunnel 8, as will be explained below with reference to FIGS. 3a to 3e.

From the outlet lock 9 of the drier 6 the vehicle bodies 2 are moved into a cooling zone 11 which again contains normal atmospheric air which is maintained at the desired temperature by means of a cooling unit 12.

As is shown in FIG. 2, in particular the width of the locks 7 and 9 and the internal width of the drying tunnel 8 exceed the width of the vehicle bodies 2 to be treated by the smallest possible amount. In this way the quantity of inert gas which is required and optionally circulated in the locks 7, 9 and in the drying tunnel 8 is kept as small as possible.

Reference will now be made to FIGS. 3a and 3b which show the construction of the lock 7, as an example for the locks 7, 9, and the manner in which the vehicle bodies 2 are transferred from the normal atmosphere prevailing in the pre-drier 4 to the inert atmosphere present in the drying tunnel 8. The construction of the outlet lock 9 is in principle the same, although the vehicle bodies 2 are transferred from the inert gas atmosphere of the drying tunnel 8 to the normal atmosphere of the cooling zone 11 in the inverse direction.

The lock 7 includes a housing 13 having an inlet chamber 14 and an outlet chamber 15. The inlet chamber 14 is located at the same height as the tunnel of the pre-drier 4; its inlet opening 16 can be closed with a roll-up door 17. The outlet chamber 15 is located at the same height, is aligned with the drying tunnel 8 and communicates with the interior thereof via an outlet opening 18. The outlet opening 18 may also be provided with a roll-up door.

Below the inlet chamber 14 and the outlet chamber 15 the housing 13 of the lock 7 forms a kind of “immersion bath” 19, this designation being explained below. The immersion bath 19 communicates via comparatively large-area openings 20, 21 with both the inlet chamber 14 and the outlet chamber 15.

Direct atmospheric communication between the inlet chamber 14 and the outlet chamber 15 is prevented by a vertically disposed partition 22, which extends downwardly to somewhat below the level of the floor 23 of the inlet chamber 14 and the floor 24 of the outlet chamber 15.

A swivelling arm 25 is pivoted to the lower edge of the partition 22, which swivelling arm 25 can be swivelled in a motor-driven manner from the position shown in FIG. 3a, in which its free end extends into the lower region of the inlet chamber 14, to the position shown in FIG. 3e, in which its free end extends into the lower region of the outlet chamber 15, and vice versa.

A mounting frame 26 which includes a platform 27 carrying the vehicle body 2 is pivoted to the free end of the swivelling arm 25. The platform 27 is provided with a conveying system which is compatible with the conveying system present in the remaining part of the installation. The mounting frame 26 can be rotated through at least 360° and back by means of a motor (not shown).

The outlet chamber 15 of the lock 7 contains the same inert gas atmosphere as the drying tunnel 8 at approximately the same temperature. The immersion bath 19 is also filled with inert gas; however, this gas has a higher density than the inert gas in the outlet chamber 15 and the normal atmosphere in the inlet chamber 14, so that it forms substantially a “substratum” to both the atmosphere in the inlet chamber 14 and the inert gas atmosphere in the outlet chamber 15. Mixing of the different atmospheres via the openings 20, 21 is kept as low as possible.

Different densities of the inert gas atmospheres in the outlet chamber 15 and the immersion bath 19 can be achieved in different ways: firstly, it is possible to use different gases as inert gases. For this purpose the immersion bath 19 may be filled, for example, with CO₂ and the outlet chamber 15 with nitrogen. Because CO₂ is heavier than nitrogen and is also heavier than the atmosphere contained in the inlet chamber 15, about which more will be said below, the separation of the atmospheres in the desired manner is maintained.

However, it is preferred if the same inert gas, for example, only nitrogen, is used in the outlet chamber 15 and in the immersion bath 19. In this case the higher density of the inert gas in the immersion bath 19 is brought about by a lower temperature. For example, the temperature of the inert gas atmosphere in the immersion bath 19 may be approximately 20° C., while the above-mentioned drying temperature from 40° C. to 150° C. prevails in the outlet chamber 15.

FIGS. 3a to 3e show how the vehicle bodies 2 coming from the pre-drier 4 are conducted through the lock 7. FIG. 3a shows how a vehicle body 2 is moved on to the support platform 27 through the inlet opening 16 of the inlet chamber 14, with the roll-up door 17 open, by means of a conveying system (not shown in detail). The support platform 27 is initially aligned horizontally. The conveying system mounted thereon can therefore take over the vehicle body 2 directly from the conveying system of the pre-drier 4. The roll-up door 17 is now closed again.

The vehicle body 2 can then remain for a certain time in the position shown in FIG. 3a, in which it is flushed with inert gas supplied via nozzles (not shown).

Next, the support plate 27 together with the vehicle body 2 is swivelled clockwise through approximately 90° until support platform 27 and vehicle body 2 are approximately vertical. This is represented in FIG. 3b. The swivelling arm 25 now begins to swivel anticlockwise, whereby the vehicle body 2 is immersed “head first” in the cold inert gas of the immersion bath 19. The swivelling movement of the swivelling arm 25 may be accompanied by a larger or smaller swivelling movement of the mounting frame 26 about the pivot axis 28, via which it is connected to the swivelling arm 25.

In this way the position shown in FIG. 3c, in which the swivelling arm 25 is positioned vertically and the support platform 27 with the vehicle body 2 is positioned horizontally, is reached. The immersion process thus takes place with minimum disturbance of the atmospheres present in the inlet chamber 14 and the immersion bath 19.

The anticlockwise swivelling movement of the swivelling arm 25 is continued, optionally again with a superposed swivelling movement of the mounting frame 26, about the pivot axis 28. In this way the position represented in FIG. 3d is reached, in which the free end of the swivelling arm 25 just extends into the outlet chamber 15 of the lock 7, and the support platform 27 with the vehicle body 2 is again vertical. The front part of the vehicle body 2 already projects into the warmer inert gas of the outlet chamber 15 while the rear part is still in the colder inert gas of the immersion bath 19.

There now follows another clockwise swivelling movement of the mounting frame 26 about the pivot axis 28, through approximately 90°, so that the support platform 27 and the vehicle body 2 are finally again horizontal (cf. FIG. 3e). The vehicle body 2 can now be moved in the direction of the arrow in FIG. 3e from the outlet chamber 15 into the drying tunnel 8 and can be taken over by the conveying system of the latter.

The above description of the operations taking place in the lock 7 makes it clear that the introduction of the vehicle bodies 2 into the inert gas atmosphere of the drying tunnel 8 takes place “in steps”. The expression “in steps” is understood to mean the conducting of the vehicle bodies 2 through different atmospheres in which the densities of the inert gas are different: the inlet chamber 14 contains only as much inert gas as enters said chamber through the “steaming” of inert gas from the immersion bath 19 via the opening 20 and, if applicable, via flushing nozzles which flush the body 2. The lowest density of the inert gas is therefore to be found in the inlet chamber 14. The highest density of the inert gas is present in the immersion bath 19, so that especially intensive flushing of the vehicle bodies 2 takes place in the latter.

The quantity of normal atmosphere, in particular oxygen, which is entrained into the immersion bath 19 via the vehicle body 2 is already sharply reduced because of the pre-flushing taking place in the inlet chamber 14. When the vehicle bodies 2 emerge from the immersion bath 19 into the outlet chamber 15 they are practically completely free of foreign gases, in particular oxygen.

As mentioned above, comparable operations take place in the outlet lock 9, although the transition here is from the inert gas atmosphere of the drying tunnel 8 to the normal atmosphere of the cooling zone 11. The primary purpose of the outlet lock 9 is to allow the least possible inert gas to cross into the cooling zone 11, which inert gas would be lost for the inert gas circulating in the drier 6.

FIG. 1 shows a conduit 29 which opens into the drying tunnel 8 from below. A secondary flow of inert gas is constantly drawn from the drying tunnel 8 via this conduit 29 and supplied to a condensate separator 30. The condensate separator 30 has one or more cooled plates past which the inert gas drawn from the drying tunnel 8 flows. Substances which can be separated out by condensation, in particular solvents, water, cracking products and other substances which are released from the coating of the vehicle bodies 2 during the drying process in the drier 6, are precipitated as condensate on the surfaces of the cooled plates.

To the extent that this precipitate comprises low-viscosity liquids, these can simply drain from the plates and be discharged in a suitable manner. However, in many cases high-viscosity precipitates are produced which must be removed mechanically and/or using solvents. For this purpose it is advantageous if the plates inside the condensate separator 30 are either easily accessible or easily removable.

In the process described, the inert gas which has been purified in the condensate separator 30 is cooled to a temperature which approximately matches the temperature of the cool inert gas in the immersion bath 19 of the lock 7. It is therefore returned via a conduit 31, in which a fan 32 is located, directly to the immersion bath 19 of the lock 7. Cooled inert gas may also be introduced into the immersion bath of the lock 9 in a corresponding manner.

The portion of a painting installation 101 illustrated in FIGS. 4 and 5 strongly resembles the embodiment described above with reference to FIGS. 1 and 2. Corresponding parts are therefore denoted by the same reference numerals, increased by 100. The spray cabin 103, the pre-drier 104 with the heating unit 105 and the cooling zone 111 with the cooling unit 112 are found unchanged in the embodiment of FIGS. 4 and 5. A drier 106, the drying tunnel 108 of which is filled with inert gas, is again located between the pre-drier 104 and the cooling zone 111. This inert gas is heated by means of a heating unit 110 to the above-mentioned temperature from 40° C. to 150° C.

However, unlike that of the embodiment of FIGS. 1 and 2, the drying tunnel 108 is not located at the same vertical level as the pre-drier 104 and the cooling zone 111, but is raised somewhat above that level. The transfer of the vehicle bodies 102 from the pre-drier 104 to the drying tunnel 108 and from the drying tunnel 108 to the cooling zone 111 is again effected via an inlet lock 107 and an outlet lock 109. The structure of the two locks 107, 109 is substantially the same, so that it will be sufficient to explain in more detail the construction of the lock 107 in the following exposition.

The lock 107 again comprises a housing 113 with an inlet chamber 114 and outlet chamber 115. The two chambers 114 and 115 communicate via a large-area opening 121 in the top of the inlet chamber and the bottom of the outlet chamber 115. A swivelling arm 125 is pivoted at one end to the housing 113 and can be swivelled back and forth in a motor-driven manner through an angle of approximately 90°. On its free end it again carries via a pivot axis 128 a mounting frame 126 with a support platform 127 which can receive the body 102 and is again provided with a conveying system which is compatible with the conveying systems in the pre-drier 104 and in the drying tunnel 108. The mounting frame 126 can be swivelled through at least 90° about the pivot axis 128 by means of a motor.

The inlet chamber 114 again has an inlet opening 116 which is closable by a roll-up door 117.

The outlet chamber 115 is filled with hot inert gas the density of which is lower than that of the normal atmosphere which is present in the inlet chamber 114. This means that the atmospheres in the inlet chamber 114 and the outlet chamber 115 remain largely separate from one another without a mechanical barrier. The inert gas atmosphere in the outlet chamber 115 may be substantially the same as the inert gas atmosphere in the drying tunnel 108.

The transfer of the vehicle bodies 102 through the lock 107 into the drying tunnel 108 is effected in the embodiment of FIGS. 4 and 5 as follows:

First, the swivelling arm 125 adopts the approximately horizontal position shown in FIG. 4. The mounting frame 126 is rotated with respect to the swivelling arm 125 so that the support platform 127 is horizontal. The roll-up door 107 can now be opened and a vehicle body 102 can be moved on to the support platform 127 by means of the conveying system. The roll-up door 107 is closed and the mounting frame 126 is rotated anticlockwise through approximately 90° so that the support platform 127 and the body 102 are approximately vertical. This is the position shown in FIG. 4. The rear of the vehicle body now projects into a corresponding downwardly recessed portion of the inlet chamber 114.

Next, the swivelling arm 125 is swivelled clockwise through approximately 90°, optionally accompanied by a swivelling movement of the mounting frame 126 about the pivot axis 128. In the course of this swivelling movement of the swivelling arm 125 the vehicle body 102 is guided upwardly in an arc into the outlet chamber 115 of the lock 107 until a position is finally reached in which the swivelling arm 125 is approximately vertical and the vehicle body 102 is approximately horizontal. The vehicle body 102 can then be taken over by the conveying system in the drying tunnel 108.

The operations in the outlet lock 109 follow the reverse sequence.

As in the embodiment of FIGS. 1 and 2, a secondary flow of inert gas is drawn from the inert atmosphere of the drying tunnel 108 via a conduit 129 and supplied to a condensate separator 130. The processes taking place in the condensate separator 130 and the construction thereof are identical to the processes and construction in the first embodiment. However, because a cooled inert gas is not used in the embodiment of FIGS. 4 and 5, the inert gas cooled in the condensate separator 130 must be reheated to the temperature prevailing in the drying tunnel 108. For this purpose the inert gas leaving the condensate separator 130 is supplied via a conduit 131, in which a fan 132 is located, to the heating unit 110 of the drying tunnel 108.

The flushing processes in the embodiment of FIGS. 4 and 5 are similar to those of the embodiment of FIGS. 1 and 2. That is, pre-flushing with inert gas, which optionally is also directed at the vehicle body 102 via nozzles, takes place in the inlet chamber 114 of the lock 107, and further flushing “in steps” takes place via the inert gas atmosphere prevailing in the outlet chamber 115 until the vehicle body enters the inert gas atmosphere of the drying tunnel 108. However, the flushing achievable is possibly not so effective as in the embodiment of FIGS. 1 and 2 because there is no zone in which an especially dense, because cool, inert gas is present.

For cooling the plates contained in the condensate separator 30, 130, use may be made of the phenomenon that the inert gas stored in a pressure accumulator is decompressed and cooled as it is released. The inert gas removed continuously or intermittently from the pressure accumulator to replace lost inert gas therefore needs only to be supplied to the installation past the plates to be cooled.

1. A method for drying objects, in which the objects are moved through a drying zone in which they are cured in an inert gas atmosphere, the method comprising the steps wherein
inert gas is withdrawn continuously or intermittently from the drying zone which inert gas is conducted along at least one surface which is cooled to a temperature below the dew point of impurities contained in the inert gas in such a way that the impurities are condensed out on the cooled surface.

2. The method of according to claim 1, wherein the cooled surface is cooled by means of Peltier elements.

3. The method of claim 2, wherein the heat emitted by the cooling Peltier elements is utilised to reheat the inert gas after it has flowed past the cooled surface.

4. The method of claim 1, wherein inert gas withdrawn from a pressure accumulator, which inert gas has been cooled through decompression, is used as the cooling medium.

5. The method of claim 1, wherein low-viscosity condensed impurities are allowed to drain from the appropriately oriented cooled surface.

6. The method of claim 1, wherein condensed impurities which are solid or have high viscosity are removed mechanically and/or by solvents from the cooled surface at given time intervals.

7. An apparatus for drying objects, the apparatus comprising:
a) a drying tunnel, the interior of which is filled with an inert gas atmosphere;
b) a conveying system with which the objects can be moved through the drying tunnel; and,
c) a condensation device capable of being supplied with inert gas from the drying tunnel via a conduit and which contains at least one component having a surface which can be cooled to below the dew point of the impurities entrained by the inert gas.

8. The apparatus of claim 7, wherein the condensation device includes at least one Peltier element with which the surface of the cooled component can be cooled.

9. The apparatus of claim 8, wherein waste heat from the Peltier element is in heat-exchanging relationship with the inert gas leaving the cooled component.

10. The apparatus of claim 7, wherein the cooled component is a plate oriented substantially vertically.

11. The apparatus of claim 7, wherein the condensation device includes a heat wheel via which inflowing and outflowing inert gas can be conducted in different zones.

12. The apparatus of claim 7, wherein the cooling device includes a heat pump.

13. The apparatus of claim 7, further comprising two cooling devices are provided, through each of which alternately inert gas to be purified can flow while the other can be cleaned.

14. The apparatus of claim 8, wherein the cooled component is a plate oriented substantially vertically.

15. The apparatus of claim 8, wherein the condensation device includes a heat wheel via which inflowing and outflowing inert gas can be conducted in different zones.

16. The apparatus of claim 8, wherein the cooling device includes a heat pump.

17. The apparatus of claim 8, further comprising two cooling devices are provided, through each of which alternately inert gas to be purified can flow while the other can be cleaned.

18. The apparatus of claim 9, wherein the cooled component is a plate oriented substantially vertically.

19. The apparatus of claim 9, wherein the condensation device includes a heat wheel via which inflowing and outflowing inert gas can be conducted in different zones.

20. The apparatus of claim 9, wherein the cooling device includes a heat pump.
